(19) United States
(12) Patent Application Publication
(10) Pub. No.: US 2024/0308091 A1
(43) Pub. Date: Sep. 19, 2024

(54) Folding Knife

(71) Applicant: Ernest Emerson, Harbor City, CA (US)

(72) Inventor: Ernest Emerson, Harbor City, CA (US)

(21) Appl. No.: 18/588,582

(22) Filed: Feb. 27, 2024

Related U.S. Application Data
(60) Provisional application No. 63/435,763, filed on Dec. 28, 2022.

(51) Int. Cl. B26B 1/04

(52) U.S. Cl. CPC B26B 1/042

(57) ABSTRACT

A knife assembly, having a blade rotationally engaged therewith, is provided. The assembly is positionable within a handle cavity of a knife handle. The blade is rotatable from a closed position located within a member cavity between two side members to an open position. Spring members formed into the side members deflect within a slot defining them to provide a biasing force to hold a cross bar engaged therewith in either a first indent or second indent on the blade, to hold the blade in the open or closed position. The cross bar is out of contact with the blade in a rear surface edge in between the two detents to allow for easy movement between the open and closed positions.

This application claims priority to U.S. Provisional patent application Ser. No. 63/435,763 filed on Dec. 28, 2022.

### BACKGROUND OF THE INVENTION

### 1. Field of the Invention

The invention herein disclosed relates generally to folding knives. More particularly, it relates to a knife assembly positionable within the handle cavity of the handle of a folding knife having one or a plurality of spring members which impart biased contact to indents upon the blade of the knife to maintain the blade in an open or closed positioning.

### 2. Prior Art

### Background of the Invention

A pocketknife is a knife with one or more blades that fold into a slot positioned within the when not in use. The blade of conventional folding knives, such as pocket knives, folds out to project from the handle during use. Such pocket knives are versatile tools and may be used for anything from whittling and woodcarving to gutting and filleting small fish and are a very popular tool carried by campers, fisherman, and others.

Modernly, such pocket knives have evolved to provide the user with a biasing of the knife blade to aid in the opening to a deployed position projecting from one end of the handle that surrounds it when stowed. Conventionally, such spring assisted knives have an internal spring assembly which completes the opening process of a blade after the user has applied physical force to start the process.

However, in conventional folding knives the user must initiate the opening of the blade from the stowed position using a stud or flipper engaged to the blade. During this rotation of the blade, either to a stowed or deployed position, where it projects from one end of the handle, a cross bar contacts the curved rear surface or engagement end and holds the blade in place by settling into opposing indents on opposite ends of the curved engagement end. A biased member conventionally forces the cross bar against the exterior of the blade as it is turning and at the end of movement in either direction imparts a biased contact with a respective indent. This biased contact of the spring member into an indent or recess acts to hold the blade open or closed.

With respect to the above, before explaining at least one preferred embodiment of the folding knife device herein, it is to be understood that the invention is not limited in its application to the details of employment and to the arrangement of the components or the steps set forth in the following description or illustrated in the drawings. The various components and construction of the disclosed folding knife apparatus and methods and steps of employment thereof, are capable of other embodiments and of being practiced and carried out in various ways. All of which will be obvious to those skilled in the art once the information herein is reviewed and thus are considered within the scope of this invention.

Also, it is to be understood that the phraseology and terminology employed herein are for the purpose of description and should not be regarded as limiting. As such, those skilled in the art will appreciate that the conception upon which this disclosure is based may readily be utilized as a basis for other folding knife systems. It is important, therefore, that the embodiments, objects, and claims herein, be regarded as including such equivalent construction, operation and methodology, insofar as they do not depart from the spirit and scope of the present invention.

### SUMMARY OF THE INVENTION

The disclosed folding knife assembly herein provides a significant advancement through the provision of an internal assembly housed in a knife handle. The assembly has a U-shaped spring member formed into at least one or preferably two opposing side panels of the assembly which is operatively mounted in the knife handle. The spring members are positioned to impart a biasing force to a cross bar to maintain the crossbar biased against and positioned within respective recesses or indents formed into the rear surface edge of a folding knife blade.

The folding knife herein, employing the biasing force from the spring members against the cross bar engaged therebetween, acts as a biasing member or spring which only communicates the biasing force of the cross bar against the rear surface edge of the rotating blade when the cross bar is positioned within two indents. During rotational movement of the blade between the open and closed positions and concurrent engagements of the cross bar, with either a first indent or the second indent, biased contact of the cross bar against the surface rear of the blade ceases. This cessation of biased contact of the cross bar against the rear surface edge of the blade thereby allows for a much faster and smoother rotation of the blade between an open and closed position.

A first of the two indents is positioned upon the rear edge surface of the blade to form a biased contact with the cross bar when the blade is located to the closed position. A second of the indents is positioned on the rear edge surface of the blade for a biased contact of the cross bar when the blade is rotated to the open position. A central area of the rear edge surface of the blade, in between the first indent and second indent, preferably, has a curved edge which is sized such that there is spacing between it and the cross bar, and it does not contact against the cross bar during rotational movement of the blade from the open or deployed and closed or stowed positions.

The engagement end of the folding knife blade is operatively engaged to a pivot point within the interior of the biasing assembly herein and the knife handle when it is engaged therein. The knife blade is rotatable from a closed position, where it is located between the two side panels of the biasing assembly to an open position where the blade extends from one end of the biasing assembly and a handle, when engaged.

A first slot formed through the body of the first side panel forms the first spring member which may deflect within the slot during use. A second slot communicating through the body of the second side panel forms a second spring member which may deflect therein. Opposing ends of the cross member are coupled to distal end areas of the two respective spring members.

In use, each of the spring members has a spring or deflecting action of the material forming it and the body of the respective side panel. This deflection occurs when the engaged cross member contacts against the rear surface of the knife blade at either of a first indent or second indent. This contact of the cross member slightly bends each spring member into the slot surrounding it and forming it within the respective side panel. The resistance to this bending or deflection thereby imparts a biasing or tension of the cross bar against the first and second indents.

The first indent communicates with the cross bar only with the blade in a closed position within the member cavity and handle cavity of the knife handle to hold the blade closed. The second of the indents in this operative engagement of the blade with a pivot communicates with the biased contact of the cross bar only with the knife in the open position wherein the blade portion projects from one end of the handle of the knife.

Each spring member operatively engages with the cross bar and each has a curved or U-shape defined by the slot formed into and through the material forming the side panel in which it is positioned. To the distal end of each formed spring member is engaged the cross bar. An engagement end of each spring member is coupled to the respective side panel into which it is formed. The side panels are preferably formed of metal or a synthetic material which will bend to allow deflection of the spring member into the slot forming each spring member to thereby generate biased contact.

As noted and shown herein, in this configuration with spring members formed by slots or gaps formed through the opposing side panels, has the cross bar engaged therebetween. When the blade is rotated upon the pivot or axle of the knife assembly, the cross bar, preferably, will only communicate biased contact against the engagement end of the knife when the blade is fully rotated to an open position, projecting from one end of the knife handle, or when the blade is fully rotated to a closed position, stowed within the member cavity of the knife assembly. A bias of the two spring members against the connected cross bar acts to bias the cross bar against the rear edge of the blade to hold it in the open or closed position.

The spring members deflect within the gap of the slot in which they are formed in a direction away from the engagement end of the blade when the cross member is positioned in the first indent or in the second indent to provide the biased contact therewith. Additionally, the two spring members deflect within the slot surrounding them, substantially in the same plane as the side panels in which they are formed, by movement within the empty space there around formed by the slot or gap defining each spring member. This deflection and return to position of the spring members within the gap or slot substantially parallel to the plane of each of the side panels allows for smooth operation and the non-contact of the cross member when it rotates between the open and closed positions.

With respect to the disclosed folding knife device and system herein, before explaining at least one preferred embodiment thereof, it is to be understood that the disclosed invention is not limited in its application to the details of operation nor the arrangement of the components or the steps set forth in the following description or illustrations in the drawings. The various structural configurations and implementation of the folding knife device and system herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other folding knife systems methods, and device configurations for carrying out the several purposes of the disclosed folding knife device and system herein. Therefore, the objects and claims herein should be regarded as including any and all such equivalent construction, components, steps, and methodology insofar as they do not depart from the spirit and scope of the present invention.

It is an object of this invention to provide a folding knife assembly wherein a biased cross bar only contacts the rearward end of the knife blade with the blade either in the folded position within the cavity in the handle or in a deployed position extending from one end of the handle.

These, together with other objects and advantages, which will become subsequently apparent, reside in the details of the construction and configurations of the disclosed folding knife device and system herein as more fully hereinafter described and claimed, reference being had to the accompanying drawings forming a part thereof, wherein like numerals refer to like parts throughout.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, by the term “substantially” with regard to size or volume or mass, is meant plus or minus five percent, unless respectively otherwise defined, and by the term “substantially” with regard to alignment and positioning is meant plus or minus five percent.

### BRIEF DESCRIPTION OF DRAWING FIGURES

The accompanying drawings, which are incorporated herein and form a part of the specification, illustrate some, but not the only or exclusive examples of embodiments and/or features of the disclosed folding knife assembly and system herein. It is intended that the embodiments and figures disclosed herein are to be considered illustrative of the invention herein, rather than limiting in any fashion.

In the drawings:

FIG. 1 depicts the blade and other interior components of the folding knife assembly herein and their positioning during use.

FIG. 2 shows the knife assembly herein and, adjacent thereto, shows the two side panels each having a spring member engaged with the cross bar and the knife blade positioned between the closed or stowed positioning of FIG. 4 and the open or projecting positioning, as in FIG. 5.

FIG. 3 shows an enlarged view of an engagement end of the blade of the knife with two detents opposite an end of the spring member formed in each side panel which biases a cross bar into one of the two detents and deflects away from the opening and engagement end of the blade and within the slot to provide the biased contact of the cross member.

FIG. 4 shows another view of the folding knife assembly herein showing the knife blade positioned in the closed or stowed position within a cavity in the handle and showing the two side panels which are positioned to sandwich the blade therebetween.

FIG. 5 shows a view of the assembly herein as it would be installed in a handle cavity of a knife handle where the knife blade is in a deployed position extending from one end of the knife handle and showing the two side panels having a U-shaped spring member operatively positioned to bias the cross bar into either of two positions.

### DETAILED DESCRIPTION OF THE PREFERRED EMBODIMENTS OF THE INVENTION

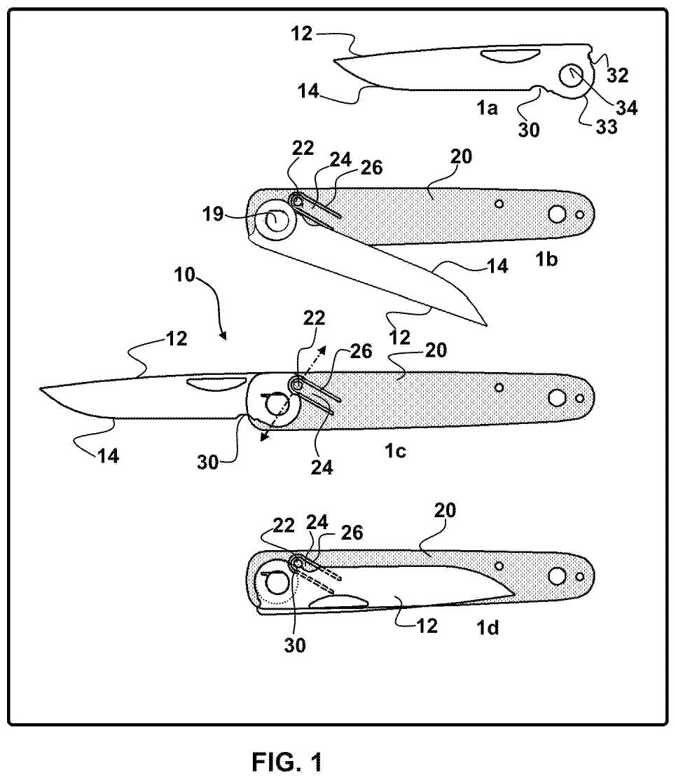

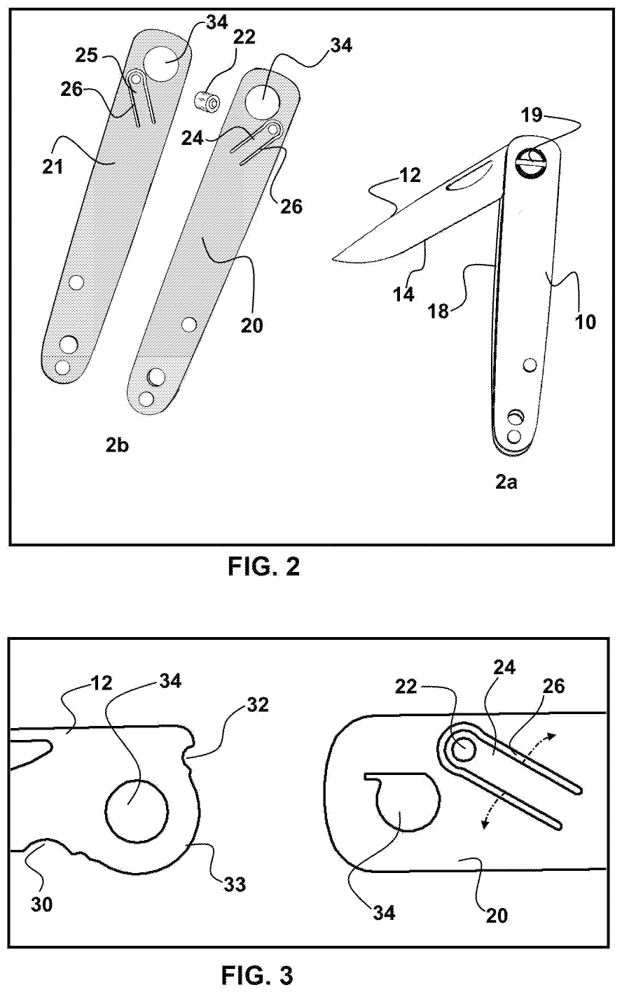

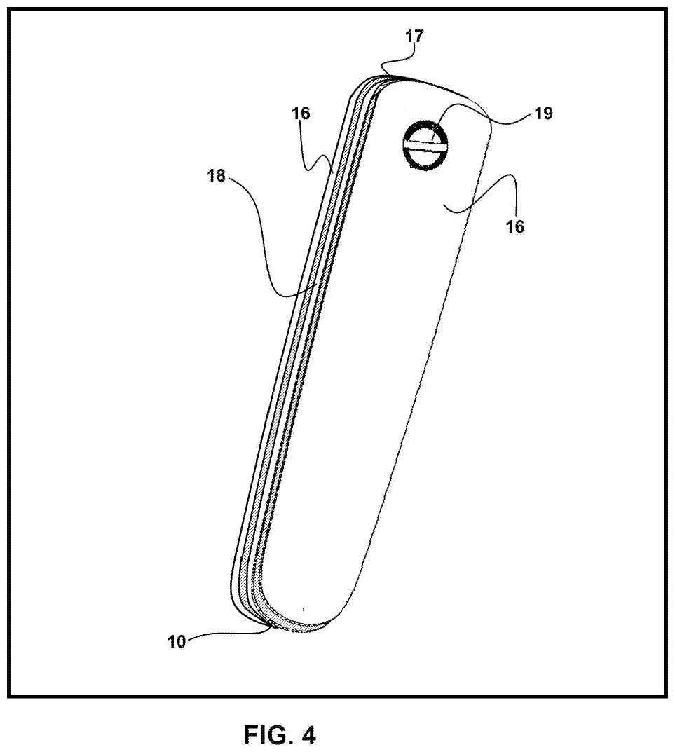

Referring now to the folding knife assembly 10 and system herein shown in simple format by the depictions of FIGS. 1-5, there is seen in FIGS. 1-2 various components of the folding knife assembly 10 herein. The folding knife assembly 10, as shown when assembled, is configured for positioning within a handle cavity 17 formed between two sides of a conventional knife handle 16 such as in FIG. 2 and FIG. 4.

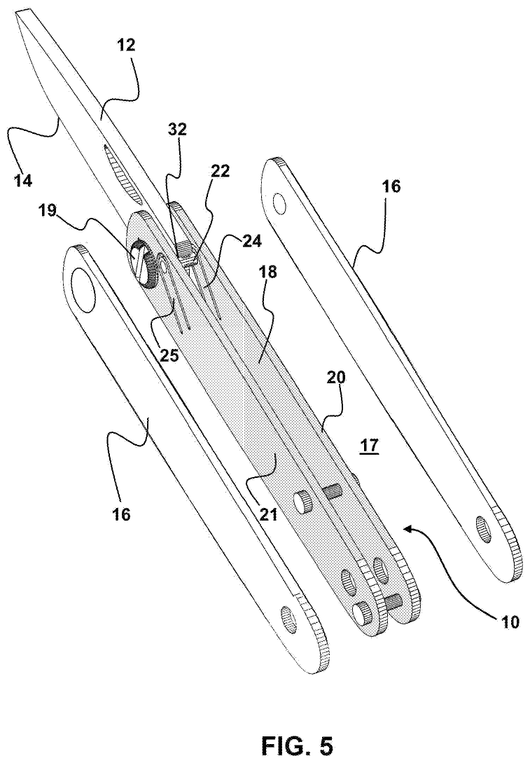

As shown in FIG. 1, a knife blade 12 has a sharp cutting edge or cutting end 14 which is configured to rotate and project from the knife handle 16 (FIG. 4). The blade 12 rotates from a retracted position, as in FIG. 1d, where it is positioned in a member cavity 18 between the first side panel 20 and second side panel 21, to a deployed position shown in FIGS. 1c and 1n FIG. 5 where it is held in that position by contact of the cross bar 22 with a second indent 32.

The knife blade 12 is rotatable in an engagement upon the axle 19 between this deployed position, shown in FIG. 1c and FIG. 5, and the stowed position shown in FIG. 1d and FIG. 4. In the stowed position, the blade 12 is positioned within the member cavity 18 of the knife assembly 10. As noted, contact of the cross member 22 with the first indent 30 will hold the blade in the stowed position until the user exerts pressure with a finger to overcome the biased contact of the cross member 22 thereby allowing rotation of the blade 12.

Also shown in figure, a first side panel 20, on one side of the member cavity 18, is located adjacent the rotatable blade 12. The second side panel 20 has been removed to better show the rotating action and detents. The cross bar 22 is shown engaged with the first spring member 24 in FIG. 1 and with the second spring member 25 in FIG. 5.

The first spring member 24 and second spring member 25 (FIG. 2) are respectively defined by a surrounding gap or slot 26 which is shown substantially U-shaped. The width of the slot 26 communicating through the first side panel 20 and second side panel 21 define the slot 26 and a deflection area for the respective spring member 24 and 25 therein. The slot 26 thus encircles three sides of the first spring member 24 and second spring member 25. So configured, the first spring member 24 extends within a slot 26 from a first end coupled to the first side panel 20 to a distal end thereof, and the second spring member 25 extends within the slot 26 from a first end thereof coupled to the second side panel 21 to a distal end thereof.

A slot 26 thus surrounds both the first spring member 24 and the second spring member 25 and allows them both to bend within the slot 26 when the user imparts rotating force to the blade 24 sufficient to overcome the biased engagement of the cross bar 22 with either the first indent 30 or second indent 32. When sufficient force is so imparted, the spring members 24 and 25 will deflect slightly within the slot 26 defining them and in a direction away from the opening 34 and the engagement end of the blade 12. In this deflection they remain substantially within the same plane as the surrounding side panels 20 and 21.

The rear surface edge 33 of the blade 12, located in between the first indent 30 and second indent 32 is formed in a configuration preferably where the rear surface edge 33 is maintained out of contact with the cross member 22 during rotation between the deployed and retracted or stowed positions or at least out of biased contact. As noted, this is preferred to allow for a quick rotation which is not imparted by biased contact of the cross bar 22. By out of contact with said cross member 22 herein is meant that a slight gap is formed between the cross bar 22 and the rear surface edge 33 or, if there is any contact there, it is not a biased contact therewith.

Shown in the figures of FIG. 1 and FIG. 5 at the engagement end of the blade 12 are the first indent 30 and a second indent 32, along with an opening 34 sized to allow rotation of the blade 12 upon a pivot pin or axle 19. The axle 19 may be a component solely of the knife assembly 10, or it may engage with the handle 16 into which the knife assembly 10 is positioned, as in FIG. 2.

As shown herein, in the rotation on the axle 19, the first indent 30 will rotate to position the cross bar 22 coupled to the formed spring members 24 and 25 into a first biased contact therewith to thereby hold the blade 12 to the closed or stowed position. The blade 12 is rotatable to the open position where the second indent 32 is in biased contact with the cross bar 22 operatively engaged with the first spring member 24 and second spring member 25. Such operative engagement may be by using fasteners, such as screws or pins or the like or by forming opposing shoulders on the cross bar 22 which are positioned within aligned openings in the first spring member 24 and second spring member 25. As noted, the knife assembly 10 will function with only one or the first spring member 24. However, for more balanced operation, longevity, and extra biasing force engagement of the cross bar 22, both a first spring member 24 and second spring member is preferred.

Depicted in FIG. 2a is the assembled knife assembly 10 ready for positioning within the handle cavity 17 (FIG. 4) of any knife handle 16 configured to hold it. As shown, the blade 12 is operatively engaged to the knife assembly 10 and rotates upon the axle 19 into and out of the member cavity 18, formed between the assembled first side panel 20 and second side panel 21. The blade 12 is shown in the side view of the knife assembly 10 in the deployed position in FIG. 1c where the second side member 21, which is not shown, and also in FIG. 5. As noted herein, the blade 12 is held in this deployed position by contact of the cross member 22 with the second indent 32.

Depicted in FIG. 3 is an enlarged view of the engagement end of the blade 12 of the knife assembly 10. Shown on the engagement end of the blade 12 are the first indent 30 and second indent 32 which are formed for biased engagement with the spring cross bar 22 when the blade 12 is rotated to either the open or closed position upon. The rotation is upon an axle 19 operatively engaged with the opening 34 formed at the engagement end of the blade 12. As noted, the first spring bar 24 and second spring bar 25, shown in other drawings, act will deflect into the slot 26 slightly when the cross bar 22 comes in contact with either the first indent 30 or second indent 32. The resistance to this deflection, by the material forming the side panels and formed spring bars 24 and 25, causes a biased contact of the cross bar 22 the surface forming the first indent 30 and the second indent 32 when the blade 12 is rotated to locate the respective indent to surround the cross bar 22. As also noted, preferably the radius of the rear surface edge 33 between the first indent 30 and second indent 32 is such that it remains out of contact with the cross bar 22 as it rotates.

In FIG. 4 is shown another view of the knife assembly 10 herein where the knife blade 12 has been rotated to the stowed or closed position in a biased positioning with the member cavity 18 of the knife assembly 10. The knife assembly 10 is shown operatively positioned within the handle cavity 17 of a knife handle 16.

The knife assembly 10, as noted, is shown in the deployed position in FIG. 5 where it has been rotated out of the member cavity 18 and the handle cavity 17 of the handle 16. The positioning of the spring members 24 and 25 to impart a biased contact against the second indent 32 acts to hold the blade 12 in this deployed position, as noted. The handle 16 is shown with opposing sides thereof which would surround the knife assembly 10 once it is operatively positioned therein.

While all of the fundamental characteristics and features of the disclosed folding knife assembly for a knife handle herein have been shown and described herein, with reference to particular embodiments thereof, a latitude of modification, various changes and substitutions are intended in the foregoing disclosure and it will be apparent that in some instances, some features of the folding knife device an system may be employed without a corresponding use of other features thereof, without departing from the scope of the invention as set forth. It should also be understood that various substitutions, modifications, and variations may be made by those skilled in the art upon their review of this specification, without departing from the spirit or scope of the invention. Consequently, all such modifications and variations and substitutions are included within the scope of the invention as defined by the following claims.

What is claimed is:

1. A knife apparatus comprising:
a knife assembly;
said knife assembly having a first side panel, said first side panel having a first spring member formed therein;
a knife blade having a cutting end and having an engagement end rotationally engaged to said first side panel;
said first spring member defined by a first slot communicating through said first side panel and extending around opposing sides and a distal end of said first spring member;
a cross member coupled at a first end thereof to said distal end of said first spring member;
a first indent at said engagement end of said knife blade;
a second indent at said engagement end of said knife blade;
a curved rear surface edge at said engagement end of said knife blade positioned in between said first indent and said second indent;
said knife blade having a closed position and having an open position;
said cross member forming a first biased contact with said first indent with said knife blade in said closed position;
said cross member forming a second biased contact with said second indent in said open position; and
said curved rear surface edge configured to remain out of contact with said cross member during rotation of said knife blade between said closed position and said open position.

2. The knife apparatus of claim 1 additionally comprising:
a knife handle having a handle cavity therein; and
said knife assembly positionable within said handle cavity.

3. The knife apparatus of claim 1 additionally comprising:
said knife assembly having a second side panel, said second side panel having a second spring member formed therein;
said second spring member defined by a second slot communicating through said second side panel and extending around opposing sides and a distal end of said second spring member;
said cross member coupled at a second end thereof to said distal end of said second spring member; and
said knife blade positioned within a member cavity in-between said first side panel and said second side panel.

4. The knife apparatus of claim 2 additionally comprising:
said knife assembly having a second side panel, said second side panel having a second spring member formed therein;
said second spring member defined by a second slot communicating through said second side panel and extending around opposing sides and a distal end of said second spring member;
said cross member coupled at a second end thereof to said distal end of said second spring member; and
said knife blade positioned within a member cavity in between said first side panel and said second side panel.

5. The knife apparatus of claim 1 additionally comprising:
said first spring member having a deflection within said first slot in a direction away from said engagement end of said blade during said first biased contact with said first indent.

6. The knife apparatus of claim 2 additionally comprising:
said first spring member having a deflection within said first slot in a direction away from said engagement end of said blade during said first biased contact with said first indent.

7. The knife apparatus of claim 3 additionally comprising:
said first spring member having a deflection within said first slot in a direction away from said engagement end of said blade during said first biased contact with said first indent; and
said second spring member having a second deflection within said second slot in a direction away from said engagement end of said blade during said first biased contact with said first indent.

8. The knife apparatus of claim 4 additionally comprising:
said first spring member having a deflection within said first slot in a direction away from said engagement end of said blade during said first biased contact with said first indent; and
said second spring member having a second deflection within said second slot in a direction away from said engagement end of said blade during said first biased contact with said first indent.

9. The knife apparatus of claim 1 additionally comprising:
said first slot being U-shaped.

10. The knife apparatus of claim 2 additionally comprising:
said first slot being U-shaped.

11. The knife apparatus of claim 3 additionally comprising:
said first slot being U-shaped; and
said second slot being U-shaped.

12. The knife apparatus of claim 4 additionally comprising:
said first slot being U-shaped; and
said second slot being U-shaped.
